(19) United States
(12) Patent Application Publication
(10) Pub. No.: US 2004/0267551 A1
(43) Pub. Date: Dec. 30, 2004

(54) System and method of restricting access to wireless local area network based on client location

(76) Inventor: Satyendra Yadav, Portland, OR (US)

Correspondence Address: EITAN, PEARL, LATZER & COHEN ZEDEK LLP, 10 ROCKEFELLER PLAZA, SUITE 1001, NEW YORK, NY, 10020, US

(21) Appl. No.: 10/603,801

(22) Filed: Jun. 26, 2003

(51) Int. Cl. G06F 17/60

(52) U.S. Cl. 705/1; 705/8

(57) ABSTRACT

A system and method for restricting access to a wireless local area network by a client based on the location of such client, such that access is denied or withdrawn to a client who is outside of such permitted area.

### BACKGROUND OF THE INVENTION

A wireless local area network (WLAN) may allow a user or client to connect to a network, such as for example, a local area network, without connecting his computer to an outlet or other wired fixture.

Unauthorized users of a network such as a WLAN who are within transmission range of an access point of a WLAN may attempt to gain access to a WLAN. Some unauthorized users may position themselves outside the boundaries of a home, office or building that is covered by a WLAN where their actions are not seen, giving them greater opportunity to gain access to the WLAN.

### BRIEF DESCRIPTION OF THE FIGURES

Embodiments of the invention will be understood and appreciated more fully from the following description taken in conjunction with the appended drawings in which:

FIG. 1 is a schematic diagram of a permitted WLAN area with at least one access point in accordance with an exemplary embodiment of the invention;

FIG. 2 is flow diagram depicting a process of using the location of a client to determine whether to grant access to a WLAN in accordance with an exemplary embodiment of the invention; and

FIG. 3 is a flow diagram depicting a process of determining location of a client in accordance with an exemplary embodiment of the invention.

### DETAILED DESCRIPTION OF THE INVENTION

In the following description, various embodiments of the invention will be described. For purposes of explanation, specific examples are set forth in order to provide a thorough understanding of at least one embodiment of the invention. However, it will also be apparent to one skilled in the art that other embodiments of the invention are not limited to the examples described herein. Furthermore, well-known features may be omitted or simplified in order not to obscure embodiments of the invention described herein.

Unless specifically stated otherwise, as apparent from the following discussions, it is appreciated that throughout the specification, discussions utilizing terms such as “processing,” “computing,” “calculating,” “determining,” or the like, refer to the actions and/or processes of a computer, computer processor or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices. The term ‘location’ as used in this application may refer to an absolute location of an object or to a location of an object relative to the location of another object. For example, ‘location’ of a client as used in this application may refer to the location of such client relative to the location of a signal receiver such as an access point or some other object associated with a WLAN. ‘Location’ may refer to a physical location. In some embodiments, the distance between two objects may define the location of an object relative to another object. By way of further example, the location of a client relative to a signal receiver such as an access point may take into account horizontal, and/or vertical distance between them, such that if a client and an access point occupy similar horizontal coordinates, but are on, for example, different floors of a building, such positions may be considered different locations. The term signals may include for example data, voice, images or other information formats as are transmitted over a network such as for example a local area network or a wireless local area network. The EEEE 802.11b-1999 standard, published 7 Nov. 2001, also known as WiFi, is an example of a standard protocol specification used in WLAN communication.

The processes and functions presented herein are not inherently related to any particular computer, network or other apparatus. Embodiments of the invention described herein are not described with reference to any particular programming language, machine code, etc. It will be appreciated that a variety of programming languages, network systems, protocols or hardware configurations may be used to implement the teachings of the embodiments of the invention as described herein. For example, while the term WLAN as used in this application may refer to a wireless link between a computer, an access point and a server or LAN, such term may also refer for example, to a wireless connection between any digital device such as, for example, a cellular phone, computer peripheral or PDA on the one hand, and a transceiver which may be linked to other electronic devices on the other hand, such that the linked devices constitute a network such as a micronet, scatternet or piconet, each of which may in certain embodiments be considered a WLAN as is used in this application. In other embodiments, a WLAN may include, for example, a local satellite or cable TV or data system that provides residents of a particular building or residential area with wireless access to TV, radio or other broadcasts, based on requests for access made by a resident's TV or radio.

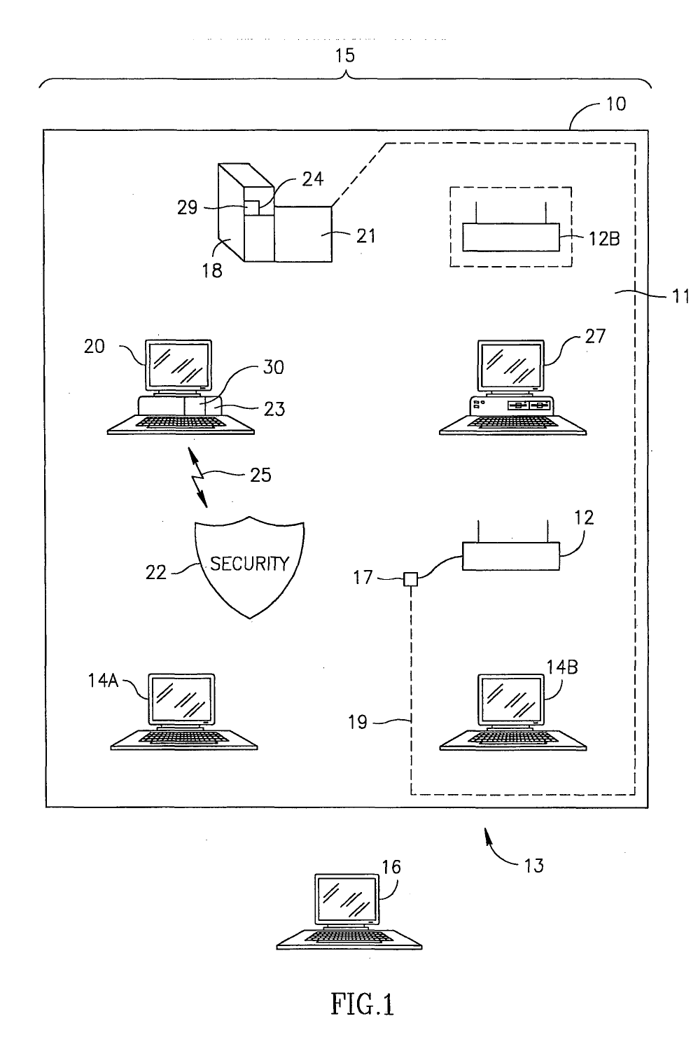

Reference is made to FIG. 1, a schematic diagram of a permitted area 11 with at least one access point 12 in accordance with an embodiment of the invention. Permitted area 11, as bounded by perimeter 10, may define the area in which it may be desired that authorized clients be permitted to access the WLAN 15. In an exemplary embodiment of the invention, access point 12 may be placed at a fixed orientation and known location within permitted area 11. Access point 12 may be a unit or system that wirelessly receives and transmits signals, including signals received wirelessly, to and from clients, and serves as a relay or interface between a client who may be communicating wirelessly, and other components of the network, such as for example a LAN server. Access point 12 may include, for example, an Ethernet port, a radio communication unit and sometimes a modem. Other or additional components may also be used in access points 12. In some embodiments, access point 12 may be connected to components of WLAN 15, such as for example a server 18, by way of a wall outlet 17 and a wired or other physical (e.g. fiber optic) link 19. Alternatively, access point 12 may be connected to WLAN 15 by wireless link. In some embodiments, a server 18 may house or be associated with a processor 21 (such as for example one or more CPU's or microprocessors) that may be connected to an authentication system 24 that may store, receive and evaluate password or other client identification information or criteria to determine whether a client that requests access to WLAN 15 is authorized to receive such access. Geographic or other location coordinates corresponding to the location of perimeter 10 or the boundaries of permitted area 11 may be stored in a data storage component 23 of policy server 20, in server 18, or in another device to which policy server 20 or server 18 are connected, such that for each of several radial directions emanating from access point 12, policy server 20 or server 18 may determine whether a particular location is within permitted area 11 or is in an area outside 13 permitted area 11. Policy server 20 may be connected to or may include a memory 30. Policy server may be connected to an alert system 25, such as for example an alarm, or security system 22, that may issue an alert or implement defensive measures in the event of attempts to gain access to the WLAN 15 by unauthorized clients. Policy server 20 or a data storage component 23 may also store criteria for determining the kind of measures to take under various circumstances, and records of past attempts to gain access. In exemplary embodiments of the invention, some or all of policy server 20, authentication system 24, data storage component 23 or other components of the invention described herein may be combined into or divided among varying numbers of components, which may or may not be integrated into a single unit.

Memory 30 of policy server 20 may be, for example, a random access memory (RAM), read only memory (ROM), dynamic random access memory (DRAM), etc, or other suitable memory. Authentication system 24 may include server memory 29 which may be, for example, a RAM, ROM, DRAM, etc, or other suitable memory.

In an exemplary embodiment of the invention, a client 14 may initiate contact with a wireless component, such as for example an access point 12, of WLAN 15 requesting access to the WLAN 15. Such request may be made by client 14a which broadcasts a signal that is received by a signal receiving unit such as for example access point 12. WLAN 15 or authentication system 24 may initiate log-on procedures or request client 14a to provide identification information. Access point 12 and/or another signal receiver such as for example a desk top computer 27 with a wireless receiver whose location is known, may receive and relay the signals transmitted by client 14a, or may evaluate such signals on their own or in conjunction with either or both of server 18 and policy server 20, to determine the location of client 14a. In some embodiments, the calculation of the location of client 14a may be performed by a processor 21 that may be connected to server 18, or by policy server 20, by authentication system 24 or by other components connected to the WLAN 15. Such calculation may be based on the strength or direction of signals received by access points 12 and 12b or upon other factors. Processor 21 may in some embodiments be a standalone processor, or alternatively, processor 21 may be for example a microprocessor, a ‘computer on a chip’, etc. that may be located inside another component operably connected to WLAN 15. In some embodiments, processor 21 may, by operating software, perform some or all of the functions of other components items described above such as policy server 20 and authentication system 24.

The location of a client 14 may be compared to the coordinates of permitted area 11 as may be stored in policy server 20, in server 18, or in another component associated with WLAN 15. If client 14a is within permitted area 11, policy server 20 may deliver a signal to authentication system 24 indicating that there is no objection on the basis of location to granting client 14a with access to WLAN 15. If outside client 16 is determined to be in area outside 13 of permitted area 11, policy server 20 may deliver a signal to authentication system 24 to prevent access from being granted to outside client 16. In some embodiments, a record of an attempt to access a WLAN from an area outside 13 a permitted area 11, as well as data about an outside client 16 which made such attempt, may be stored in policy server 20, in data storage component 23 or in another component connected to server 18 or WLAN 15. In certain instances, such as for example, in the event of repeated attempts of an outside client 16 to gain access from an area outside 13 of permitted area 11, policy server 20 may issue an alert 25 and/or deliver a signal to security system 22 to intercept or otherwise prevent outside client 16 from gaining access to WLAN 15. In exemplary embodiments, outside client 16 may be a client 14a who has ventured out of permitted area 11, after being earlier authenticated for access onto a WLAN 15. In some embodiments policy server 20 may initiate access point 12 or some other signal receiver to survey the location of client 14a on a continuous or periodic basis. In other embodiments, access point 12 may initiate surveys of the location of client 14a in order to check that client 14a is within permitted area 11.

In exemplary embodiments of the invention where a single access point 12 is installed, a location of a client 14a may be determined in various ways. For example, information available from the signals broadcast by client 14a, such as for example the strength of a signal broadcast by a client 14a, may provide a measurement of distance or range of client 14a from access point 12. In some circumstances, this single measurement may be sufficient to determine that outside client 16 is in the area outside 13 of permitted area 11. In some circumstances, a previously authorized client 14b, which has access to WLAN 15, may listen to signals from client 14a which scans an area seeking connection with an access point 12. Data, such as for example, location data of other client 14b and the strength or direction of the signal received by other client 14b from client 14a, may be transmitted to server 18 or policy server 20, and may be combined with data about the signal received by access point 12 from client 14a, such that policy server 20 may be able to calculate the radial direction from which client 14a is broadcasting, and hence the location of client 14a. In an exemplary embodiment, such other client may be a stationary object such as for example, a desktop computer 27 or a printer whose location is known, that may be operably connected to a network and that may have a capability of receiving a wireless signal. In some embodiments, such object may be considered a signal receiver.

In an exemplary embodiment, access point 12 may include one or more smart antenna systems, as are know in the art such as for example a switched beam antenna or an adaptive array antenna, which may be capable of determining the direction from which a client 14a is broadcasting. In certain embodiments, the direction of the source of the signals transmitted by a client 14a may be in used in the calculation of the location of client 14a. Other methods of calculating distance or direction of a client 14 for purposes of determining location of client 14a are also possible. Such methods may include using location fingerprinting schemes that may match certain characteristics, such as for example multipath characteristics, of a signal that is received by a signal receiver against known characteristics of signals in a permitted area 11.

In some embodiments of the invention that include at least two access points 12 and 12b, determining the location of a client 14a may be performed in various ways. Access point 12b is shown within a dashed line as it may not be present in all embodiments. For example, each of access points 12 and 12b may measure the strength of signals transmitted by client 14a. Access point 12 may compare the relative strength of the signal it receives from client 14a with the strength of the signal received by access point 12b to determine the whether client 14a is within the permitted area 11. Alternatively, or in addition, the direction of the source of the signals transmitted by client 14a and received by access points 12 and 12b may also be compared as part of determining the location of client 14a In other embodiments, other methods of determining location of client 14a may include using smart antennas, location fingerprinting, etc.

In some embodiments, a greater number of access points 12 may be used. Such greater number of access points 12 may, for example, increase the precision of the location calculation. In some embodiments access points 12 may be placed around the perimeter 10 of permitted area 11. Other methods of determining the location of client 14a based on the signals received by access points 12 may include the use of, for example, smart antennas, location fingerprinting, as is mentioned above, or other methods. In some of such embodiments, a location of a client 14a may be determined using two signal receivers, such as for example access points 12 and 12b, or with one access point 12 and another client such as client 14b, or with one access point 12 and a another signal receiver such as for example a desk top computer 27 with a wireless receiver whose location is known.

In exemplary embodiments, perimeter 10 may be coextensive with physical dimensions of a structure, such as for example the walls of a home or office. For example, the area outside 13 of perimeter 10 may be a neighboring office space, an area open to the public or another space from which it is desired that access to the WLAN 15 not be available. In other embodiments, perimeter 10 may be unbounded by a physical structure, and may be defined by desired spatial coordinates of the permitted area 11. Perimeter 10 may encompass for example, an indoor, an outdoor or a combination indoor-outdoor space that may be defined by spatial coordinates and from which access to the WLAN is to be restricted. For example, perimeter 10 may encompass an outdoor seating area of a sidewalk cafe within which customers may be permitted to access a WLAN, but outside of which no access is to be provided. Similarly, perimeter 10 may include a conventional office space plus an outdoor working area such as a patio or picnic area from which WLAN access may be established.

In an exemplary embodiment of the invention, the location of a signal receiver such as an access point 12 may be fixed upon its installation, and the location or coordinates of such access point 12 relative to the boundaries of permitted area 11 in various directions may be inputted and stored in, for example a data storage component 23 server 18 or policy server 20, to serve as a location reference point for signals received from a client 14a. In other embodiments, an access point 12 may be moveable within a permitted area 11, and its altered location may be automatically calculated by server 18, by other access points 12b, by a combination of server 18 and other access points 12b or by other components associated with the WLAN 15. Such moveable access points 12 and 12b may be useful for purposes such as for example, temporarily increasing WLAN capacity to account for temporary increases in the number of uses in a permitted area 11. In some embodiments, one or more of access points 12 and 12b may be located outside of permitted area 11. Access point 12 and 12b may be linked, either wirelessly or by a wired link 19 by way of a LAN outlet 17, to a server 18, to each other or to other components associated with WLAN 15.

Client 14a may, in certain embodiments, be a portable computer such as a laptop equipped with wireless capabilities. In other embodiments, client 14a may be for example, a PDA, cellular phone, two-way radio or other electronic instrument or appliance capable of wireless transmission and receipt of data from an access point 12.

Server 18 may, in an embodiment of the invention, be a standard LAN server or a server adapted for servicing WLANs. In other embodiments, server 18 may include, for example, a data storage component, a memory 29, a processor 21 or transceiver capable of selectively providing access to data or to a network.

Authentication system 24 may, in an embodiment of the invention, be one or more of various LAN authentication system such as those associated with Microsoft Windows™ NT or Novell's NetWare™. The location of a client 14a as being within permitted area 11 may be transmitted as a specific signal that may be required by authentication system 24 for granting access to WLAN 15. Alternatively, location of a client 14a may be a pre-requisite to client's 14a initiating log-on procedures with authentication system 24. In some embodiments, the location of client 14a may be the only criteria used by authentication system 24 for determining whether to grant, deny or withdraw access to a WLAN 15.

In an exemplary embodiment, authentication system 24 may be included in or made part of server 18 or policy server 20. Alternatively, authentication system 24 may be a separate system associated with server 18, policy server 20 or other components connected to the WLAN 15. In some embodiments, authentication system 24 may be a system using pre-defined criteria such as, for example, a frequency, wavelength or other-distinguishing characteristic of client 14a that may be a basis for selectively granting, denying or withdrawing access by client 14a to a WLAN 15.

In an exemplary embodiment, policy server 20 may be a WLAN control station such as a personal computer or work station in which policies for granting access to the WLAN may be stored in a data storage component 23 and called upon by authentication system 24. In some embodiments, policy server 20 may be combined with or made part of authentication system 24 or may be stored in or made part of one or more of access points 12 or server 18. In certain embodiments, policy server 20 may store data about failed attempts to access WLAN 15, such as access attempts by outside client 16, the frequency of such attempts or the identity of the outside client 16 making the attempt, etc. The parameters to be invoked by policy server 20, such as for example spatial coordinates of permitted area 11, the number of attempts to gain access that are permitted before security system 22 is alerted, as well as other factors, may in some embodiments be set, determined or adjusted by an operator or other party responsible for WLAN 15.

In an exemplary embodiment, security system 22 may include, for example, an alarm or alert system 25 that alerts a network operator or other personnel that outside client 16 is attempting to gain access to the WLAN 15. In other embodiments, security system 22 may include a mechanism that permanently blocks outside client 16 from gaining access to the WLAN 15 after outside client 16 makes a number of attempts to gain access from area outside 13 permitted area 11. Similarly, security system 22 may include procedures or other functionalities that alert a client 14a which already enjoys access to a WLAN, that such client 14a has left permitted area 11, and that his access will be withdrawn.

In an exemplary embodiment of the invention, access points 12, 12b and other access points (not shown) may each collect data on the signals received from client 14a and such data may be used to determine the location of client 14a. Other WLAN 15 components such as for example desktop computers or other clients in permitted area 11 may also collect data on a location of a client 14a. In some embodiments, the direction of the source of the signals received by each of access points 12, 12b, and other access points may be collected, using for example, smart antennas. Signal strength data, and/or signal directional data may be collected from access points 12b and other access points by, for example, access point 12 or by server 18 or policy server 20. Such collected information may be processed by, for example, a triangulation algorithm, by location fingerprinting, as is mentioned above, or by other means, to determine the location of client 14a or by other means.

In some embodiments it may be desirable, for reasons such as speed, performance or bandwidth limitations to employ separate or dedicated signal receivers such as signal receiver pairs (which may include, for example, Radio Frequency and base band components), one or more of which may be a standard system to receive and transmit data between client 14a and server 18 or other components of WLAN 15, and one or more of which may be devoted to determining, tracking or monitoring the location of a client 14a within a permitted area 11. Signals receiver may in certain embodiments be housed in a single access point 12 or unit or, alternatively, may be in two or more discreet access points 12 or physical locations.

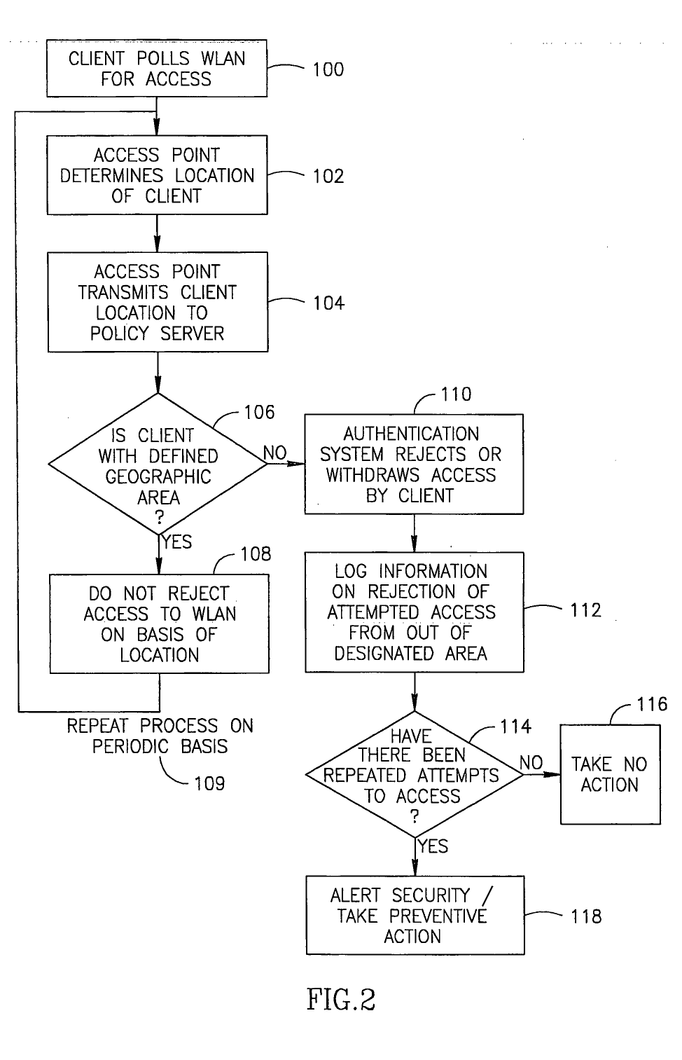

FIG. 2 depicts a series of operations for one embodiment where multiple signal receivers are used determine whether to grant access to WLAN 15 in accordance with an exemplary embodiment of the invention. In block 100 a client 14a polls or otherwise contacts a WLAN 15 or a signal receiver such as an access point 12 seeking connectivity to signal receiver such as an access point 12, and access to a WLAN. In block 102 access point 12 or another component operably connected to WLAN 15, may determine the location of client 14a. Determining the location of client 14a may be done in various ways including, for example, comparing the relative strengths of signals received by access points, as is discussed in the description of FIG. 1 above, based on the direction of signals received by access points 12, 12b and other access points, as is discussed in the description of FIG. 1, or, for example, by smart antennas. Other methods of determining the location of client 14a may also be possible. Location of a client 14a may also be calculated by server 18 or policy server 20, based on information provided by access point 12, or by another signal receiver or wireless component connected to a WLAN 15, whose location is known.

In block 104, access point 12 may transmit data on the location of client 14a to policy server 20. In block 106, policy server 20 may determine whether the location of client 14a is within the permitted area 11. Such determination may be based on for example the coordinates of permitted area 11 stored in, for example, policy server 20. If client 14a is within permitted area 11, policy server 20 may permit authentication system 24 to proceed with the authentication of client 14. In some embodiments, policy server 20 may deliver a signal to authentication system 24 indicating that client 14a is within permitted area 11, and such signal may be a pre-requisite for authentication system 24 to grant access to client 14a. In some embodiments of the invention, this process may be repeated on a regular, periodic or occasional basis (block 109) to ensure that client 14a maintains access to WLAN 15 only while within permitted area 11. In such embodiments, if client 14a leaves permitted area 11, policy server 20 may alert client 14a that his access will be terminated, and/or may terminate such access. In other embodiments, location of client 14a may be determined only once or only occasionally in an access session as a basis for an initial grant of access to WLAN 15.

In the case of an outside client 16 who requests access, authentication system 24 may in block 110 reject outside client's 16 request for access to WLAN 15. In block 112, policy server 20 may log or record data relating to rejected attempts to gain access from the area outside 13 permitted area 11. Such records may include for example time, location, number of attempts and if possible identifying characteristics of the outside client 16 making such attempt. If policy server 20 determines that the number of attempts to gain access (block 114)exceeds a predefined limit or otherwise matches designated criteria such as identity of known hackers, etc., policy server 20 may in block 116 activate an alert 25 to indicate that an unauthorized user is attempting to gain access to WLAN 15. Security system 22 may dispatch a guard to intercept outside client 16, and may in block 118 temporarily prevent any further grants of access, or may take other intrusion reaction measures.

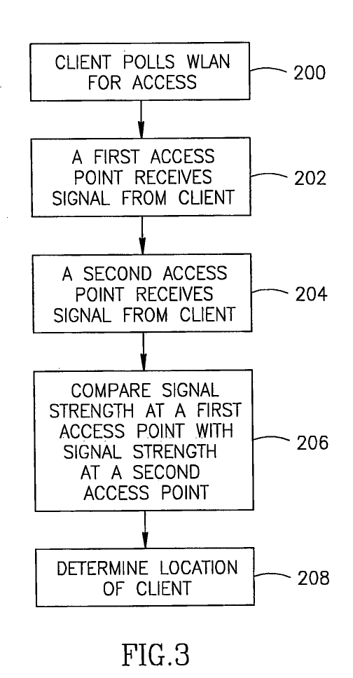

Reference is made to FIG. 3, a flow diagram depicting a process of determining location of a client 14a in accordance with an exemplary embodiment of the invention. In block 200, client 14a polls access point 12 seeking access to WLAN 15. In block 202, client 14 broadcasts a signal that may be received by access point 12. Access point 12 may collect data such as for example, signal strength or directional data about the signal broadcast by client 14a and may transmit such data to any or all of policy server 20, server 18 or to another access point 12b. In block 204, access point 12b may receive a signal from client 14a, and transmit data about such signal to any or all of policy server 20, server 18 or access point 12. One or more of the components receiving such signal data may in block 206, compare the data received by access point 12 and access point 12b, and may on such basis, determine the location of client 14 in block 208. Other methods for determining location may also be used.

In other embodiments, the strength or the direction of the source of a signal may be measured by a third access point 12 and transmitted to server :18, policy server 20 or to another access point 12. The location of client 14a may be calculated using such three relative strengths of signals using a triangulation algorithm, using location fingerprinting, as is described above, or through other means. In still other embodiments, an access point 12 may include smart antennas that may be capable of determining the direction and distance of broadcasting client 14a from an access point 12. Other number of access points 12 may also be used, and other methods of determining the location of a client relative to an access point 12 may also be possible.

The methods or processes described herein may be performed, for example, by a controller or processor 21 executing software or instructions which may be stored, for example in memory 30 or on a floppy disk, hard disk, flash card or other suitable storage medium, for example on data storage component 23. Other methods or processes may be used. Data storage component 23 or memory 30 may be or may be included in, for example, an article (e.g., disk jacket, case, holder, etc.) including a storage medium holding instructions that may be executed.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

I claim:

1. A method comprising determining whether to grant a client access to a wireless local area network based on a location of said client.

2. A method as in claim 1, comprising determining whether to withdraw said access from said client based on the location of said client.

3. A method as in claim 1, comprising receiving information available from signals broadcast by said client to determine the location of said client.

4. A method as in claim 1, comprising receiving signals from two or more signal receivers to determine the location of said client.

5. A method as in claim 4, wherein receiving signals by two or more signal receivers to determine the location of said client comprises receiving signals by an access point and a signal receiver whose location is known.

6. A method as in claim 1, comprising determining a direction of a source of a signal received from said client; and
using said direction to determine the location of said client.

7. A method as in claim 1, comprising determining a location fingerprint of a signal received from said client; and
using said location fingerprint to determine a location of said client.

8. A method as in claim 1, comprising receiving signals from three or more signal receivers;
triangulating said signals; and
using said triangulated signals to determine the location of said client.

9. A method as in claim 1, comprising defining boundaries of a permitted area.

10. A method as in claim 9, comprising storing coordinates of said boundary in a policy server.

11. A method as in claim 9, comprising recording instances of attempts to gain access to said wireless local area network from outside said boundary.

12. A method as in claim 11, comprising issuing an alert upon an attempt to access said wireless local area network from outside said boundary.

13. A method as in claim 9, comprising implementing intrusion reaction measures upon an attempt to access said wireless local area network from outside said boundary.

14. A method as in claim 1, comprising accepting signals from a signal receiver of a signal receiver pair.

15. A system comprising:
a signal receiver to determine a location of a client relative to a permitted area; and
a processor to withhold access of said client to said wireless local area network if said client is outside of said permitted area.

16. A system as in claim 15, wherein said processor is to withdraw access to said wireless local area network from said client if said client is outside of said permitted area.

17. A system as in claim 15, wherein said signal receiver is to use information from a signal broadcast by said client to determine said location of said client.

18. A system as in claim 15, comprising two signal receivers, wherein one of said two signal receivers is an access point, and another of said signal receivers includes a wireless component whose location is known.

19. A system as in claim 15, wherein said signal receiver is to use a direction of the source of a signal received from said client to determine the location of said client.

20. A system as in claim 15, wherein said signal receiver is to use a location fingerprint of a signal received from said client to determine the location of said client.

21. A system as in claim 15, comprising a data storage component to record instances of attempts to gain access to said wireless local area network area from outside of said permitted area.

22. A system as in claim 15, comprising an alert unit to issue an alert of attempts to gain access to said wireless local area network area from outside of said permitted area.

23. A system as in claim 15, wherein said signal receiver is a signal receiver of a signal receiver pair.

24. A system as in claim 15, comprising a policy server to store data on boundaries of said permitted area.

25. A computer system comprising:
an access point;
a processor to restrict access of a client to a wireless local area network based upon location of a client; and
a security unit to issue an alert upon access attempts from outside a permitted area.

26. A computer system as in claim 25, including a policy server to store coordinates of a permitted area.

27. A computer system as in claim 26, including a memory.

28. An article comprising:
a storage medium, having stored thereon instructions, that when executed, results in the restriction of access of a client to a wireless local area network based upon the location of said client.

29. An article as in claim 28, comprising instructions to determine the location of said client.

30. An article as in claim 28, comprising instructions to issue an alert upon access attempts from outside a permitted area.
